(19) United States
(12) Patent Application Publication
(10) Pub. No.: US 2002/0194933 A1
(43) Pub. Date: Dec. 26, 2002

(54) Device for measuring and controlling a liquid flow

(76) Inventor: Bernardus Johannes Gerardus Maria Roelofs, Eindhoven (NL)

Correspondence Address: JACOBSON HOLMAN, PROFESSIONAL LIMITED LIABILTY COMPANY, 400 SEVENTH STREET, N.W., WASHINGTON, DC, 20004, US

(21) Appl. No.: 10/153,178

(22) Filed: May 23, 2002

(30) Foreign Application Priority Data
May 23, 2001 (NL) 1018148

(51) Int. Cl. G01F 1/00; F16K 7/04

(52) U.S. Cl. 73/861.49; 251/4

(57) ABSTRACT

The invention relates to a device for measuring a liquid flow through a tube, which tube, which has an inflow side and an outflow side disposed under said inflow side, is filled with said liquid, as a result of which a liquid column is formed in the tube, with human senses or sensors being used for measuring the liquid flow, and as well as applications therefor.

The invention furthermore relates to a device for adjusting the flow-through opening of a flexible tube through deformation for the purpose of dosaging a medium, which tube has an inflow opening and an outflow opening.

According to the invention, the device for measuring a liquid flow is characterized in that the measuring of the change in the length of the growing liquid in time is a measure of the liquid flow. In addition to that, the device for adjusting the flow-through opening of the flexible tube according to the invention is characterized by deforming the flexible tube about an axis substantially parallel to the direction of flow of the medium that flows through the flexible tube.

The invention relates to a device for measuring a liquid flow through a tube, which tube, which has an inflow side and an outflow side disposed under said inflow side, and is filled with said liquid, as a result of which a liquid column is formed in the tube, with human senses or sensors being used for measuring the liquid flow, and as well as applications therefor.

The invention also relates to a device for adjusting the flow-through opening of a flexible tube through deformation for the purpose of dosaging a medium, which tube has an inflow side and an outflow side.

### PRIOR ART

Other optical techniques for measuring a liquid flow are known from U.S. Pat. No. 4,936,828, in which the volume of falling drops is measured, or from EP-0 610 418, in which the volume increase of growing drops hanging from an outflow opening is measured as a function of time for the purpose of computing the liquid flow. The image of the hanging drops is projected on a camera and the liquid flow is computed by means of image processing software. An important drawback when using this method in liquid flow feedback-controlled infusion pumps is the instability in the position of the drops. Thus, the drops do not fall in a direction perpendicularly to the optical axis in all cases, nor are the drops stationary while hanging from the outflow opening. This makes it necessary to carry out time-consuming, intense image processing.

Another application is known from U.S. Pat. No. 4,938,072, in which the liquid level in a vertical measuring tube, which is open at the upper side, increases when the liquid flows into the tube from below. The position of the meniscus level in the liquid is measured with a row of optical detectors. Once the upper side of the tube has been reached, a valve at the bottom side of the tube is opened, so that the tube will empty again. As a result, measuring is not possible during a certain period, however. This drawback is obviated by U.S. Pat. No. 5,355,735, in which the tube is disposed horizontally along a row of detectors and a gas bubble is injected near the inlet for the liquid flow, the transport speed of which gas bubble through the tube can be measured by means of the detectors as a measure of the liquid flow. This drawback of U.S. Pat. No. 5,355,73 is overcome in U.S. Pat. No. 5,483,830 by first collecting the liquid in the container and subsequently measuring measured amounts of liquid, which automatically flow out when a siphon overflows. The automatic emptying of the container therein can be compared with the flushing of a toilet. In this method, however, there is no question of a direct relation between the emptying of the container on the one hand and the liquid flow from the filling aperture on the other hand, and consequently there is no question of measuring in a through-flow system by means of which a pump can be controlled. Another patent, viz. U.S. Pat. No. 4,446,993, utilizes the capillary properties of a narrow tube, such as the tubes that are generally used in pipetting liquids, for measuring out liquid volumes. These capillary properties are undesirable in a liquid flow meter, however, because the capillary action leads to a flow-through resistance for the liquid flow that is to be measured.

The sensitivity of the methods described above is limited by the dimensions of the containers or tubes and the number of detectors disposed beside the tubes or containers. This drawback is overcome in EP-0 610 418, in which the image of the rising liquid column is projected on a camera, after which the liquid flow is computed by means of image processing software. Another solution for this problem is provided by EP-0 541 501, in which a linear CCD sensor is used. All the methods that have been described above are costly and difficult to incorporate in medical infusion systems. In most cases these methods are used for checking on infusion pumps or monitoring the urine production of patients, as described in U.S. Pat. No. 5,483,830.

### OBJECT OF THE INVENTION

The invention has been made with a view to eliminating the above limitations by providing new measuring methods and apparatuses which result in effective, inexpensive, sensitive, real-time systems such as medical infusion systems, urine-trend indicators or metering devices in soft drink dispensers.

Liquid Flow Measurement of a Downward Flow in a Tube Which is Open at the Bottom Side

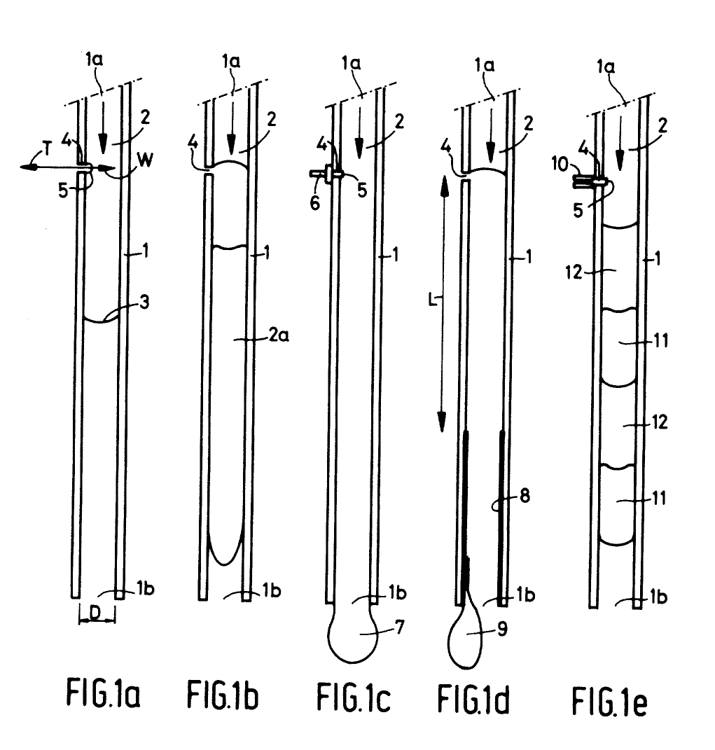

A device as described in the first paragraph, an embodiment according to the invention of which will be explained below with reference to the appended FIGS. 1a-1e, is characterized in that the measuring of the change in length of the growing liquid column in time is a measure of the liquid flow. As a result of said growing, the meniscus level of the liquid will move in the direction of the outflow side of the tube. The change in the length of the liquid column and in the position of the meniscus, measured in time, is a measure of the liquid flow. All this is shown in FIG. 1a. A suitable selection of the materials of the liquid 2 and the tube 1 having an inflow opening 1a and an outflow opening 1b prevents the liquid from draining off in a thin layer along the tube wall. In addition to that, the diameter of the tube and the properties of the material of the tube wall are such that the liquid is not retained in the tube by capillary action. It is the environmental pressure in combination with the surface tension of the liquid that keeps the liquid inside the tube. As long as the surface tension is such that the liquid can form drops larger than the width of the internal diameter D of the tube and the meniscus 3 is convex, which means that the cohesion between the liquid molecules is greater than the adhesion between the liquid molecules and the wall molecules, the liquid tends to flow through the tube as a “whole” and not as a thin layer on the inner side of the tube wall.

A special embodiment of the device according to the invention, by means of which the liquid flow and a liquid dosage can be measured continuously and precisely, is characterized in that the tube is provided with an orifice near its inflow opening, which orifice places the inside of the tube into communication with the outside environment, such that the surface tension of the liquid in the orifice attempts to find an equilibrium with the hydrostatic pressure of the weight of the liquid column that is present under the orifice, and wherein the length of the free liquid column that has formed after the disruption of said equilibrium is a measure of the amount of liquid that has been released.

The length of the liquid column in the tube is limited by using an orifice 4 in the tube wall which has a small diameter in comparison with the diameter D of the tube 1, which orifice places the inside of the tube 1 into communication with the environment. The fact is that the liquid column will break at the location of the orifice 4 when the hydrostatic pressure W (see arrow W in FIG. 1a) of the weight of the liquid column hanging under the orifice 4 in the tube 1 is greater than the compensating surface tension T of the liquid (see arrow T in FIG. 1a). As a result of the hydrostatic pressure of the weight of the liquid column at the location of orifice 4, a small gas bubble 5 will begin to grow, as is shown in FIG. 1a. When the weight becomes too great, the column 2a will break and the liquid the will flow from the tube in the form of a column segment, as is shown in FIG. 1b.

The free column segment 2a thus formed has a characteristic length, and thus a volume which can be precisely determined, which length depends on the dimension of the orifice 4 and the interaction between the liquid and the tube at the location of the orifice 4. From this a liquid dosage can easily be derived.

The surface tension of the liquid as well as the dimension of the orifice 4 prevent the liquid from exiting through the orifice 4. This physical phenomenon can be compared with inflating a balloon. Initially it is difficult to inflate the balloon; once a threshold value is exceeded, however, inflation is much easier.

It may be possible to shut off the orifice, for example by means of a valve. If a valve 6 is arranged in front of the orifice 4, as is shown in FIG. 1c, it is possible to allow the liquid column to continue to grow. In the closed position of the valve 6, the liquid will flow out in the form of drops 7 or in the form of a jet, depending on the magnitude of the liquid flow, at the outflow opening 1b of the tube 1. The magnitude of the liquid flow to which the invention relates usually leads to drops being formed.

When the surface tension in a small orifice 4 is utilised for causing the column 2 to break without making use of a valve, as is shown in FIG. 1d again, the length of the column at which said column breaks can be determined in part on the basis of a changing property of the material of the inner wall. In accordance with the invention, the tube may be provided with a liquid-attracting material on the inner side, near the outflow opening, for the purpose of limiting the liquid column to a specific length.

By applying a material 8 to the inner wall near the outflow opening 1b, which material leads to an adhesion between the liquid molecules and the wall molecules which is greater than the cohesion between the liquid molecules, the liquid is additionally drawn in the direction of the opening 1b, as it were, and the liquid column will thus break at a specific length L (see FIG. 1d) with greater precision. This makes it possible to obtain a dosage amount which is easier to reproduce.

The opening of the orifice 4 by means of a valve 6 as well as the utilisation of the liquid-attracting action of the wall material 8 make it possible to achieve that the volume of the liquid column that breaks off will be the same at all times. This known volume enables calibration both of the liquid dosaging method and of the liquid flow measuring method, because the length L and the tube diameter D fully determine the volume of the liquid being released.

When a comparison is made with the prior art devices as described above, in which measurements are carried out on hanging drops, it can be stated that the vibrating drops are “tamed” by the tube. Also in the process of drops growing and falling from an outflow opening, the moment of falling depends on the surface tension and the adhesion of the liquid to the outflow opening. Comparable to EP-0 610 418, the growth of the liquid column is a measure of the liquid flow, and the precise dimension of the length of the column at the point at which the column breaks is not relevant. This measurement still needs to be calibrated, however, with the exact information as regards to the drop size at any, albeit random moment.

Using a liquid-attracting material 8 near the outflow opening 1b in the tube, the calibration volume is determined by the internal diameter of the tube and the length of the tube up to the level of a convex meniscus in the liquid. When a valve 6 is used, it is even possible to adjust and precisely predetermine the length at which the column will break. This self-calibrating characteristic constitutes an advantage over EP-0 610 418, in which the optical magnification factor must be determined. It also constitutes an advantage over U.S. Pat. No. 4,936,828, in which the number of falling drops must be counted, whose size can never be exactly determined, however. It also constitutes an advantage over the measuring methods which utilise a riser tube for measuring the liquid flow, in which the amount of liquid that remains behind when the tube is emptied renders the measurement more difficult.

The above-described physical phenomenon, in which the environmental pressure and the surface tension hold the liquid in its position in the tube as long as the surface tension of the liquid in the orifice 4, which is intended is to have the liquid column “drop” or break at that location, is greater than the hydrostatic pressure at that position, which pressure is determined by the mass of the liquid column below the position of the orifice, can be combined with another physical phenomenon, in which the speed at which the surrounding gas flows into the tube is reduced by a gas flow restrictor 10 in combination with the orifice 4. This will be explained with reference to FIG. 1e.

If a restrictor 10 is arranged between the orifice 4 and the environment, this will reduce the speed at which the liquid column 11 moves to the outflow opening 1b in the tube, once it has broken off. Said speed does not depend on the speed at which the liquid flows into the tube 1 at the inflow opening 1a as a result of the existence of a liquid flow. The time during which the broken liquid column, which is now a liquid segment 11, moves “freely”, on the other hand, does depend on the speed at which the liquid flows. The fact is that the newly grown column blocks the orifice 4 again, and the rate at which that happens depends only on the liquid flow.

With the passage of time, a pattern of liquid segments 11 and gas segments 12 characteristic of the liquid flow is thus formed. The dimensions of the segments are a measure of the liquid flow through the tube. In this element of the invention, a kind of implicit “clock” is combined with the liquid flow proper in the measurement by the flow restrictor 10 for the inflow of gas into the tube 1. The inflow resistance depends on the viscosity of the inflowing gas; if the type of gas does not change it will not be necessary to calibrate the internal “clock” anew each time.

The speed at which a liquid segment 11 moves through the tube can also be reduced by placing a flow restrictor for the liquid near the outflow opening 1b of the tube. In that case, the different viscosity of different liquids makes it difficult to calibrate the “clock”, however.

Another possibility of the physical phenomenon, in which the equilibrium in the hydrostatic pressure and the surface tension of the liquid, combined with a liquid-repellent action of the wall material, is utilised for determining the dosage or the liquid flow, shows the use of a tube whose diameter increases in the direction of the outflow opening, in such a manner that the surface tension of the liquid at the bottom of the liquid column attempts to find an equilibrium with the adhesion of the liquid to the tube wall, after which this equilibrium will be disrupted when a specific diameter is reached and liquid can flow off along the wall, until the surface tension of the liquid at a point in the tube above the position of said equilibrium is greater than the cohesion between the liquid and the tube wall, and wherein, after the equilibrium has been disrupted, the free liquid column that has then formed is a measure of the released amount of liquid and measuring of the liquid flow from the new, downwardly growing liquid column is possible again.

Compared with the method that is currently being used by nurses for checking on the liquid flow when administering an infusion, namely the counting of drops in a so-called drip chamber over a specific period of time, a liquid flow measuring method in which the speed of the liquid flow can be checked on at one glance from the length of the segments can have a time-saving effect. On the other hand it is also possible, by making the orifice 4 optional, to continue to count the number of drops per unit time for determining the liquid flow. The only thing that is required in that case is not to remove an optional, removable cover from the orifice.

Liquid Flow Measurement by Measuring the Difference in Light Intensity

A next element of the invention relates to the injection of the growth of the liquid column. Compared with the method measuring from drops, in which a volumetric value of drops is to be computed on the basis of two-dimensional image information, a one-dimensional measuring method will suffice in a liquid flow measuring method in which a tube is used. After all, the diameter of the tube is known, so that only the length of the liquid column must be determined. This can be realised with a one-dimensional sensor. According to U.S. Pat. No. 5,355,735, the sensor may consist of a row of photosensitive cells that detect the position of the meniscus in the liquid. A higher resolution can be achieved with a line CCD as shown in U.S. Pat. No. 5,333,497.

According to the invention, the device in which the tube is transparent is characterized in that one sensor is disposed beside the tube, from which electro-magnetic radiation directed at the tube and the liquid column is reflected, the reflection being a measure of the length of the liquid column in the tube. Comparable to EP-0 610 418, it is not the current position of the meniscus that is important but the increase of the length of the column. Preferably, the relation between the length of the liquid column and the measured light intensity is proportional. When the tube in which the liquid column is present is irradiated with light in a direction parallel to the axis of the tube, said light will reflect from the boundary layer defined by the tube material and the gas in the tube as a result of the smaller optical refractive index of said gas. When the boundary layer is defined by the tube material and the liquid, the light rays will be broken or adsorbed. According to British patent No 1,426,824, the contrast that is achieved with the reflection method is higher than the contrast that is achieved with the method in which the light source is disposed diametrically opposite the sensor on the other side of the tube, in which the broken light rays provide the contrast required for determining the position of the meniscus. The problem of inhomogeneities in the light gap that is used in GB-1,426,824 is remedied in U.S. Pat. No. 5,333,497 through the use of a diffuser in the light gap.

The main advantage of the use of reflective rays, however, is the fact that the relation between the length of the column and the amount of light that is reflected is proportional.

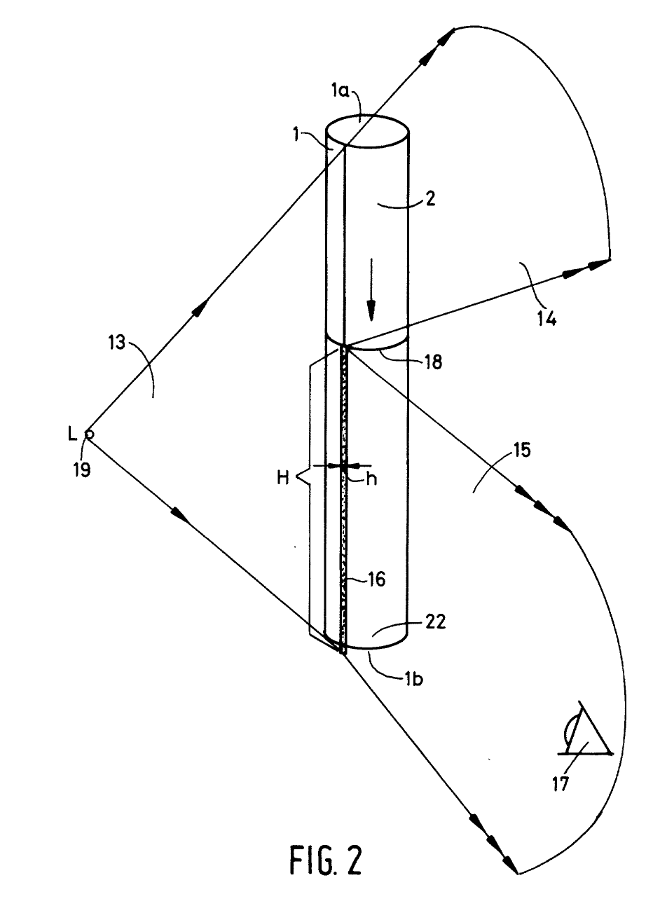

With transparency-based systems, the determination of the position of the meniscus is rendered more difficult by the parallax of the width of the tube. Different parts of the meniscus absorb the light rays in dependence on the position of the meniscus relative to the position of the sensor. In addition to that, the meniscus reflects a different amount of light with each change of position. When the reflection at the transition between the tube and the gas is used, the same part of the meniscus is used at all times for determining the transition from gas to liquid, as is shown in FIG. 2.

By making use of the reflection, the length of the liquid column can therefore be measured by means of a single sensor 17, which measures the radiation intensity, and wherein a single radiation point source 19 (L) rather than a line source may irradiate the tube 1. The upper electromagnetic rays 13 propagate straight ahead (possibly broken) as transmitted radiation 14 in the liquid-filled part 2 of the tube 1. The lower rays 15 are reflected from the transition 16 between the tube material and the gas in the part 22 of the tube that is not filled with liquid yet, in which the sensor 17 detects the overall intensity of the reflective rays that fall within its range of vision. Owing to the cylindrical mirror optics of the curved tube wall, a reflected light line 16 whose width h depends on the curvature parallel to the axis of the tube and the position of the point source 19 relative to the sensor 17 is formed upon irradiation of the tube. Since said width h remains constant within the range of the length of the liquid column, only the length H of the light line 16 is a determining factor as regards the progress of the meniscus 18 in the direction of the outflow opening 1b.

Liquid Flow Control with Torsion Valve and Torsion Pump

Another element of the invention relates to a device for adjusting the flow-through opening of a flexible tube through deformation for the purpose of dosaging a medium, which tube has an inflow opening and an outflow opening.

A liquid flow can be controlled in two ways: viz. by varying the pressure across a flow restrictor for said liquid flow or by varying the flow restrictor whilst the pressure on said flow restrictor remains the same. The latter method is used with ordinary water taps. Especially in the case of small liquid flows, this method exhibits a low resolution and a limited degree of adjustability. In order to improve the resolution, a hose through which the liquid flows is constricted to a greater or smaller extent. An example of such a restrictor is the regulator in infusion systems, in which the nurse reduces the flow-through opening in the hose by means of a wheel in a conical gap, parallel to the axis of the hose or flexible tube. Also this method of controlling the flow-through opening is still too crude when compared with the invention as described above.

In accordance with the invention, the reduction of the flow-through opening is not obtained by exerting a direct force perpendicularly to the liquid flow and to the axis of the hose, but by deforming the flexible tube about an axis substantially parallel to the direction of flow of the medium that flows through the flexible tube. In particular, the device may comprise torsion means in which the flexible tube can be received, which torsion means are rotatable about the axis in question and which twist the tube during operation. Said twisting of the hose results in the hose being constricted, as a result of which the flow-through opening is reduced along the length of the twisted portion, and consequently the flow resistance is increased. Such an adjustment of the flow-through opening furthermore exhibits a wider range of adjustment, because it is possible to twist the hose many times around its axis, even to the point where the flow is completely blocked.

With a valve according to the prior art, for example a water tap or the infusion system discussed in the preceding paragraph, wherein the hose is squeezed together in a direction perpendicularly to the axis of the hose, the range of adjustment amounts to maximally the diameter of the hose, so that a costly, precise construction is required in order to obtain a comparable resolution or adjustability.

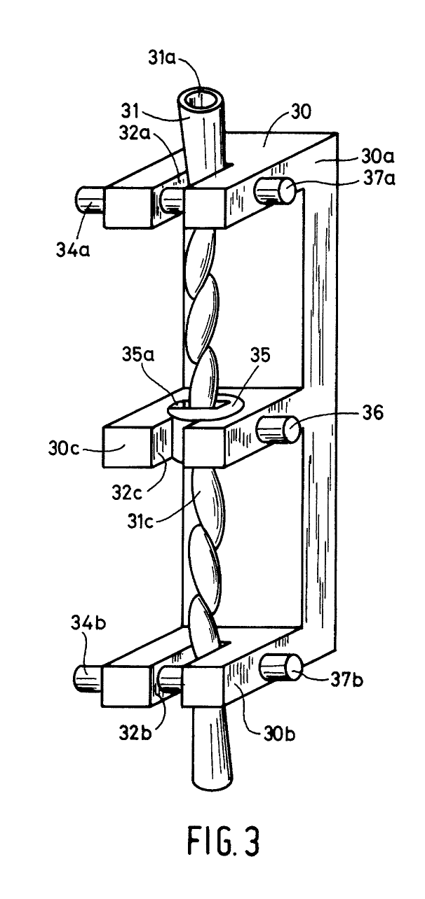

FIG. 3 shows an embodiment of a device according to the invention. At the ends 30a and 30b of a holder 30, a hose 31 is constricted slightly between slots 32a and 30b, respectively, and anchored in the slots by locking means 34a and 34b. Said slots do not shut off the hose but clamp it down sufficiently. The holder 30 is furthermore provided with a third support 30c provided with a slot 32c, in which a rotatable disk or torsion element 35 is confined. The disk 35 is likewise provided with a slot 35a which can coincide with the slot 32c for receiving the hose portion 41 as a result of the rotation of the disk 35 in the support 30c. Rotation of the disk 35 causes the hose 31 to be twisted around an axis substantially parallel to the direction of flow of the liquid. The hose 31 will be constricted as a result of being twisted, and the flow-through opening will become smaller. The disk 35 can be locked in position by the locking means 36, so that a particular flow resistance that has been set can be maintained.

In another preferred embodiment, the hose 31 is wound round a central axis. Such a construction provides a better reproducibility and possibilities of interconnecting the ends of the holder rigidly via a central axis.

As a result of the torsion effect, liquid is also forced from the hose 31 at the location where said twisting takes place. Using a cascade of twisting parts, this principle can be used to realise a peristaltic pump. The pump principle is illustrated in FIG. 3. Using valves 37a and 37b, which are capable of pinching the hose 31 to altogether, at the ends 30a and 30b of the holder 30, the inflow opening 31a and the outflow opening 31b of the hose 31 are alternately opened and closed. When the valve 37a is opened whilst the valve 37b is closed, and the hose is not twisted, the hose 31 is filled. After the valve 37a has been closed and the valve 37b has been opened, the contents of the hose are forced towards the outflow opening 31b as a result of the hose being twisted by the disk 35. In this twisted condition of the hose, the valve 37b is closed again and the valve 37a is opened, so that the hose 31 can fill again upon rotation of the disk 35 and twisting of the hose in the reverse direction. In this way, a peristaltic pumping effect is obtained. When two parallel torsion pumps operating in counter phase are used, however, a continuous liquid flow will be generated.

Applications

The elements of the invention will be explained by means of two applications thereof.

Passive Infusion System

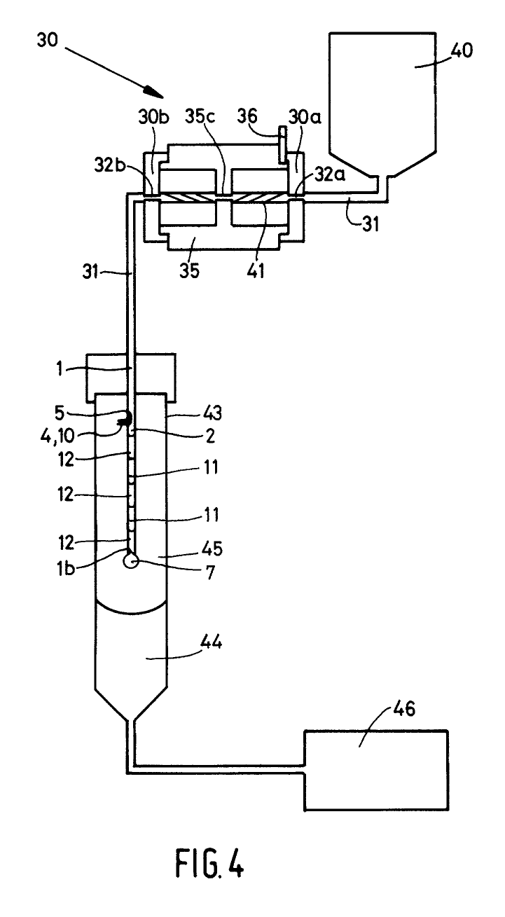

In regular infusion systems driven by the force of gravity, the liquid flow is regulated by an adjustable flow restrictor, and the nurse assesses the liquid flow via a so-called drip chamber by counting the drops that fall into said chamber. According to the invention, said drip chamber is substituted for a tube chamber 43, as is shown in FIG. 4, in which a tube 1 (similar to the tube that is shown in FIG. 1e) having a small orifice 4 provided with a restrictor 10 in the tube wall is present. In such a chamber, the drops have been replaced by a specific amount of liquid, therefore, which can be retained in the tube as long as the surface tension in the orifice 4 is sufficient.

FIG. 4 shows a tube chamber 43, at the upper side of which a tube 1 is present, which tube is connected to a hose 31 on a liquid reservoir 40, which is disposed above the complete infusion set in order to generate the hydrostatic pressure on the system, making use of the force of gravity. An orifice 4 is present at the upper side of the tube 1. As already described above with reference to FIGS. 1a-1e, the liquid column 2 will break at the location of the orifice 4 when the hydrostatic pressure in the tube 1 is greater than the surface tension of the liquid in the orifice. In the figure, a small, expanding air bubble 5 is shown to be present in the orifice 4. The liquid in the tube exhibits a convex meniscus at the bottom side of the liquid column 2 and the liquid segments 11. The concave meniscus at the upper side of the liquid segments 11 is caused by the hydrostatic underpressure at that location, which is the result of the weight of the liquid below said meniscus. A gas inlet restrictor 10 between the orifice 4 and the environment reduces the speed at which the previously formed liquid segments 11 can move towards the outflow opening 1b. Said speed, which is determined by the joint weight of all the segments and the drop 7 that may hang from the bottom side of the tube, combined with the inflow rate of the surrounding gas, is reduced by the inlet restrictor 10 obtained from the Reynolds number Re, as long as the orifice 4 is not blocked anew by the new liquid column 2.

As soon as the new column blocks the orifice 4 again, as is the case in FIG. 4 (and in FIG. 1e), the speed at which the segments move within the tube is determined by the liquid flow proper. Said liquid flow is regulated by means of the torsion restrictor/valve 30 in the infusion hose 31. Said valve is shown to comprise three segments 30a, 30b and 35. The central segment 35 can rotate relative to the outer segments 30a and 30b, which are rigidly interconnected and which are held in position by a stop 36, which functions to prevent a free flow of liquid to the (schematically indicated) patient 46. Said “free flow” always constitutes a great risk when administering infusions in the manner that has been used in practice so far, viz. when the wheel that is used therein comes loose.

Slots 32a, 32b and 35a flatten the hose 31 slightly in the centre of the segment 35 and on the outer side of the segments 30a and 30b so as to get a grip on the hose with a view to twisting it. Said slots do not shut off the hose. The hose is retained in the slots 32a and 32b by the closures 34a and 34b (see FIG. 3). The balanced twisting of the segment 35 relative to the segments 30a and 30b ensures that only the hose portion 41 within the valve 30 is twisted and not any hose portions outside the valve. The hose can eventually be shut off altogether, with the flow being shut off completely, by twisting it further and further. This infusion set can replace the sets that are currently being used, in which use is made of the force of gravity, and provides a higher degree of accuracy and safety. This set can also be used in a new type of infusion pump.

Active Infusion System

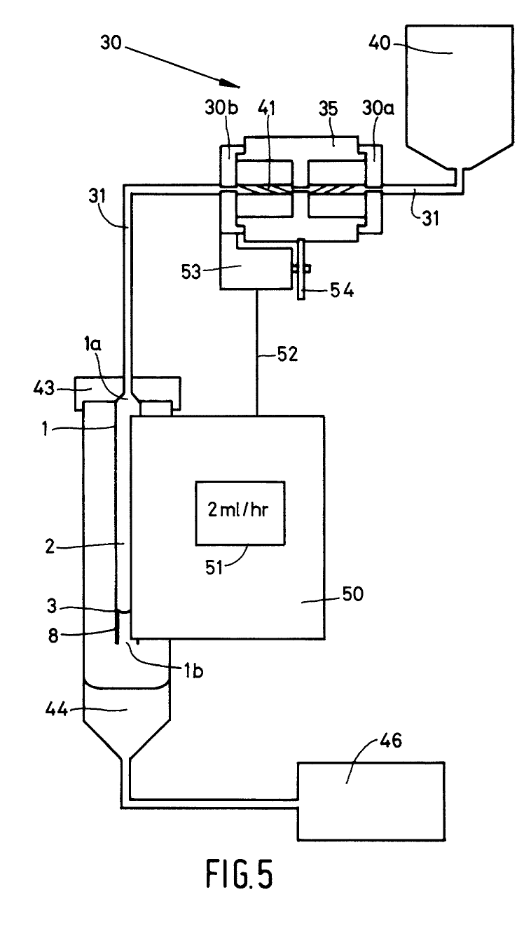

FIG. 5 shows an infusion system on the basis of the above-described infusion set, showing a tube chamber 43, at the top of which the measuring tube 1 is present. The measuring tube is connected to a liquid reservoir 40 via a hose 31. The hose 31 is passed through a liquid flow resistance regulator 30, in which the flow resistance is regulated by twisting the hose in the manner demonstrated in FIGS. 3 and 4. In an integrated measuring unit 50 (also refer to FIG. 2), the tube is exposed to electro-magnetic radiation and the growth of the liquid column 2 is detected. The length of the liquid column 2 is detected by the sensor 17 (FIG. 2) in the unit 50, which is sensitive to the light intensity and which measures the intensity of the electromagnetic radiation 15 (see FIG. 2) of a radiation source 19 (see FIG. 2), which is reflected from the inner wall of the tube 1 along the length 16 (see FIG. 2) where no liquid 2 is present yet. The change in time in the output from the sensor 17, for example a voltage signal or a frequency signal, is a measure of the liquid flow, which reduces the amount of reflected radiation 15 in a cyclical manner.

The maximum size of the liquid column 2 of each cycle is limited by the liquid-attracting property of the material 8 near the outflow opening 1b of the measuring tube 1. As a result, the liquid is deposited in equal quantities in the liquid receptacle 44 of the chamber 43, after which it flows on to the (schematically indicated) patient 46. The value of the liquid flow is shown on a display 51. By comparing the measured value with the desired value, an electrical signal can be sent through the connection 52 to the control unit 53 so as to maintain the liquid flow at the desired value that has been set. To this end, the central segment 35 of the torsion valve 30 is actuated by a drive unit (for example a motor) 53, the wheel 54 of which can cause the segment 35 to rotate. Since the hose 31 is held in position in the segments 30a and 30b on either side of the segment 35, the hose portion 41 will be twisted, as already described above. The flow resistance is thus adjusted so as to maintain the desired value of the liquid flow.

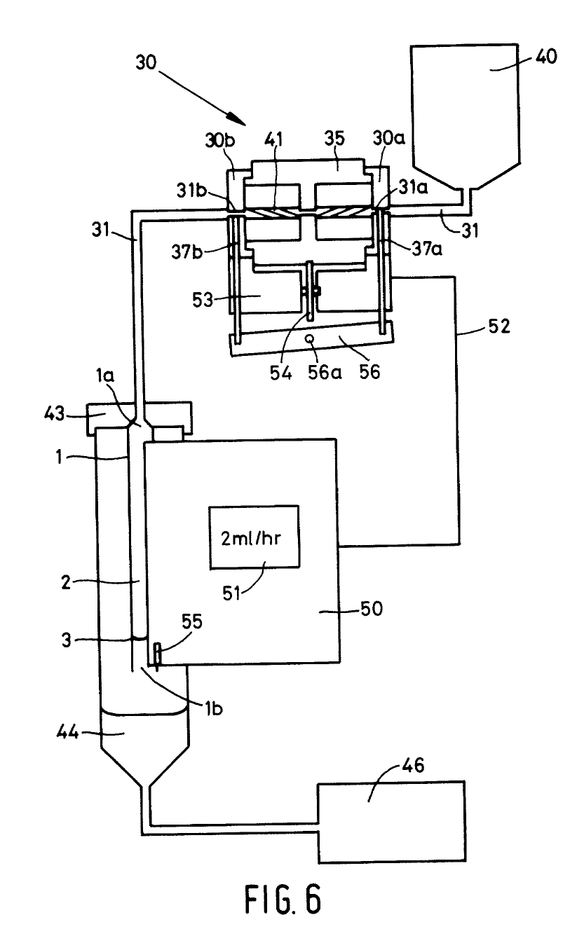

Optionally, a valve for opening the orifice 4 in the measuring tube 1, for the purpose of thus adjusting a specific length of the liquid column 2, can be integrated in the measuring unit 50 as shown in FIG. 6. The lower part of the measuring tube 2 is screened against reflecting light by means of a screen 55 in that case, as a result of which the intensity sensor 17 can relate the maximum and minimum intensity values of the reflected light 15 to the maximum length of the unscreened part of the liquid column 2. This method of calibrating the measuring system is different from the method that is based on the fixed column length, which is determined by the position of the liquid-attracting material 8 near the outflow opening 1b of the measuring tube 1, as is the case in FIG. 5. As soon as the output from the measuring unit 50 reaches the uttermost value as a measure of the moment the maximum column length is reached, the valve 6 (see FIG. 1c) in the orifice 4 will be opened, as a result of which the liquid column 2 will break off to form the liquid segment 11. The measured value, which is a measure of the liquid flow, can be used for controlling a liquid pump instead of regulating the flow resistance of FIG. 5.

FIG. 6 shows a pump which is based on the twisting of a hose 31, which is controlled via a connection 52 originating from the measuring unit 50. FIG. 6 shows the situation in which the downstream valve 37b does not constrict the hose, whilst the drive unit 53 comprising the wheel 54 causes the central rotating segment 35 of the pump to rotate, as a result of which the hose portion 41 is twisted and the liquid that is present in that portion of the hose is forced in the direction of the measuring chamber 43, because the upstream valve 37a, arranged in counter phase to the valve 37b, shuts off the hose in the direction of the reservoir 40. After the valve 37b has been closed and the valve 37a has simultaneously been opened via the lever 56 that pivots about the fixed point 56a, the twisting of the hose portion 41 is reversed, so that the original hose volume is filled with liquid from the reservoir 40 again. After the valve 37a has been closed and the valve 37b has been opened, the cycle can force liquid in the direction of the measuring chamber 43 again. This results in a peristaltic pumping action. A constant liquid flow can be generated by arranging two pumps in parallel.

One of the valves 37a or 37b can be opened and closed in various ways, for example by means of compressed air or by means of a solenoid drive, with the lever 56 closing or opening the other valve, as the case may be.

All parts of the infusion said as described above are compatible with the sterility requirements for products for individual patients, the only difference with the regular drip chamber being the fact that the outflow opening for the drops has been substituted for a measuring tube. The production cost is comparable with that of the current type of sets. The degree of precision and safety is higher. The infusion pump that can be used in this set, however, is much cheaper, more precise and intrinsically safer than all other existing infusion pumps.

Other Applications

The invention as described above can be used in many kinds of apparatuses, such as: liquid flow meters for testing other systems, apparatuses for automatically metering the amount of syrup in soft drink dispensers, apparatuses for monitoring the urine production of patience and apparatuses for dosaging reacting agents in systems in which pipettes are generally used.

1. A device for measuring a liquid flow through a tube, which tube, which has an inflow side and an outflow side disposed under said inflow side, and is filled with said liquid, as a result of which a liquid column is formed in the tube, characterized in that the measuring of the change in length of the growing liquid column in time is a measure of the liquid flow.

2. A device according to claim 1, characterized in that the tube is provided with an orifice near its inflow opening, which orifice places the inside of the tube into communication with the outside environment, such that the surface tension of the liquid in the orifice tries to find an equilibrium with the hydrostatic pressure of the weight of the liquid column that is present under the orifice, and wherein the length of the free liquid column that has formed after the disruption of said equilibrium is a measure of the amount of liquid that has been released.

3. A device according to claim 2, characterized in that said opening is provided with a restrictor for regulating the inflow of gas from the outside environment after the equilibrium has been disrupted.

4. A device according to claim 2 or 3, characterized in that the inner side of the tube is provided with a liquid-attracting material near its outflow opening for the purpose of limiting the liquid column to a specific length.

5. A device according to any one of the preceding claims, characterized in that the tube is provided with a liquid-attracting material on the inner side, near the outflow opening, for the purpose of limiting the liquid column to a specific length.

6. A device according to any one or more of the preceding claims, characterized in that the tube diameter increases in the direction of the outflow opening, in such a manner that the surface tension of the liquid at the bottom of the liquid column attempts to find an equilibrium with the adhesion of the liquid to the tube wall, after which this equilibrium will be disrupted when a specific diameter is reached and liquid can flow off along the wall, until the surface tension of the liquid at a point in the tube above the position of said equilibrium is greater than the cohesion between the liquid and the tube wall, and wherein, after the equilibrium has been disrupted, the free liquid column that has then formed is a measure of the released amount of liquid and measuring of the liquid flow from the new, downwardly growing liquid column is possible again.

7. A device according to any one or more of the preceding claims, wherein the tube is transparent, characterized in that one sensor is disposed beside the tube, on which electromagnetic radiation directed at the tube and the liquid column is reflected, the reflection being a measure of the length of the liquid column in the tube.

8. A device for adjusting the flow-through opening of a flexible tube through deformation for the purpose of dosaging a medium, which tube has an inflow opening and an outflow opening, characterized by deforming the flexible tube about an axis substantially parallel to the direction of flow of the medium that flows through the flexible tube.

9. A device according to claim 8, characterized in that the device comprises torsion means in which the flexible tube can be accommodated, which torsion means are rotatable about the axis in question and which twist the tube during operation.

10. A device according to claim 9, characterized in that the device comprises torsion means, in which the flexible tube can be received, which torsion means are rotatable about the axis in question and which twist the tube during operation.

11. A device according to claim 10, characterized in that the device comprises supporting means arranged on either side of the torsion means, in which the flexible tube can be clampingly received.

12. A device according to claim 11, characterized in that the slot can be closed by means of a catch.

13. A device according to claim 11 or 12, characterized in that said supporting means furthermore comprise a pin for locally constricting the flexible tube.

14. A device according to claim 9, characterized in that said torsion means also comprise a rotatable torsion element, which is provided with a slot for receiving the flexible tube.

15. A device according to claim 14, characterized in that the portion element can be locked in position by means of a catch.

16. A device according to claim 14 or 15, characterized in that said torsion element is rotatably mounted in a projection forming part of said torsion means, which projection is likewise provided with a slot for jointly receiving the flexible tube.

17. A method for dosaging an amount of medium present in the flexible tube, which tube has an inflow opening and an outflow opening, characterized by the steps of
constricting the flow-through opening of the flexible hose near the outflow opening,
allowing the medium to flow in via the inflow opening by reversing the twist of the hose,
constricting the flow-through opening of the flexible hose near the inflow opening, thereby enclosing a particular amount of medium,
opening the flexible hose that has been constricted near the outflow opening, and;
twisting the hose portion present between the inflow opening and the outflow opening, in order to
force the enclosed amount of medium from the flexible hose via the outflow opening;
after which the sequence of the above steps can be repeated.
